(19) United States
(12) Patent Application Publication
(10) Pub. No.: US 2002/0129038 A1
(43) Pub. Date: Sep. 12, 2002

(54) Gaussian mixture models in a data mining system

(76) Inventor: Scott Woodroofe Cunningham, Mountain View, CA (US)

Correspondence Address: JAMES M. STOVER, NCR CORPORATION, 1700 SOUTH PATTERSON BLVD, WHQ4, DAYTON, OH, 45479, US

(21) Appl. No.: 09/740,119

(22) Filed: Dec. 18, 2000

(51) Int. Cl. G06F 17/30

(52) U.S. Cl. 707/200; 707/100

(57) ABSTRACT

A computer-implemented data mining system that analyzes data using Gaussian Mixture Models. The data is accessed from a database, and then an Expectation-Maximization (EM) algorithm is performed in the computer-implemented data mining system to create the Gaussian Mixture Model for the accessed data. The EM algorithm generates an output that describes clustering in the data by computing a mixture of probability distributions fitted to the accessed data.

### CROSS REFERENCE TO RELATED APPLICATIONS

This application is related to the following co-pending and commonly assigned patent applications:

Application Ser. No. ______, filed on same date herewith, by Paul M. Cereghini and Scott W. Cunningham, and entitled “ARCHITECTURE FOR A DISTRIBUTED RELATIONAL DATA MINING SYSTEM,” attorneys' docket number 9141;

Application Ser. No. _______, filed on same date herewith, by Mikael Bisgaard-Bohr and Scott W. Cunningham, and entitled “ANALYSIS OF RETAIL TRANSACTIONS USING GAUSSIAN MIXTURE MODELS IN A DATA MINING SYSTEM,” attorneys' docket number 9142; and

Application Ser. No. _______, filed on same date herewith, by Mikael Bisgaard-Bohr and Scott W. Cunningham, and entitled “DATA MODEL FOR ANALYSIS OF RETAIL TRANSACTIONS USING GAUSSIAN MIXTURE MODELS IN A DATA MINING SYSTEM,” attorneys' docket number 9684; all of which applications are incorporated by reference herein.

### BACKGROUND OF THE INVENTION

1. Field of the Invention

This invention relates to an architecture for relational distributed data mining, and in particular, to a system for analyzing data using Gaussian mixture models in a data mining system.

2. Description of Related Art

(Note: This application references a number of different publications as indicated throughout the specification by numbers enclosed in brackets, e.g., [xx], wherein xx is the reference number of the publication. A list of these different publications with their associated reference numbers can be found in the Section entitled “References” in the “Detailed Description of the Preferred Embodiment.” Each of these publications is incorporated by reference herein.) Clustering data is a well researched topic in statistics [5, 10]. However, the proposed statistical algorithms do not work well with large databases, because such schemes do not consider memory limitations and do not account for large data sets. Most of the work done on clustering by the database community attempts to make clustering algorithms linear with regard to database size and at the same time minimize disk access.

BIRCH [13] represents an important precursor in efficient clustering for databases. It is linear in database size and the number of passes is determined by a user-supplied accuracy.

CLARANS [11] and DBSCAN [7] are also important clustering algorithms that work on spatial data. CLARANS uses randomized search and represents clusters by their medioids (most central point). DBSCAN clusters data points in dense regions separated by low density regions.

One important recent clustering algorithm is CLIQUE [2], which can discover clusters in subspaces of multidimensional data and which exhibits several advantages with respect to performance, dimensionality, initialization over other clustering algorithms.

There is recent work on the problem of selecting subsets of dimensions being relevant to all clusters; this problem is called the projected clustering problem and the proposed algorithm is called PROCLUS [1]. This approach is especially useful to analyze sparse high dimensional data focusing on a few dimensions.

Another important work that uses a grid-based approach to cluster data is [8]. In this paper, the authors develop a new technique called OPTIGRID that partitions dimensions successively by hyperplanes in an optimal manner.

The Expectation-Maximization (EM) algorithm is a well-established algorithm to cluster data. It was first introduced in [4] and there has been extensive work in the machine learning community to apply and extend it [9, 12].

An important recent clustering algorithm based on the EM algorithm and designed to work with large data sets is SEM [3]. In this work, the authors also try to adapt the EM algorithm to scale well with large databases. The EM algorithm assumes that the data can be modeled as a linear combination (mixture) of multivariate normal distributions and the algorithm finds the parameters that maximize a model quality measure, called log-likelihood. One important point about SEM is that it only requires one pass over the data set.

Nonetheless, there remains a need for clustering algorithms that partition the data set into several disjoint groups, such that two points in the same group are similar and points across groups are different according to some similarity criteria.

### SUMMARY OF THE INVENTION

A computer-implemented data mining system that analyzes data using Gaussian Mixture Models. The data is accessed from a database, and then an Expectation-Maximization (EM) algorithm is performed in the computer-implemented data mining system to create the Gaussian Mixture Model for the accessed data. The EM algorithm generates an output that describes clustering in the data by computing a mixture of probability distributions fitted to the accessed data.

### BRIEF DESCRIPTION OF THE DRAWINGS

Referring now to the drawings in which like reference numbers represent corresponding parts throughout:

FIG. 1 illustrates an exemplary hardware and software environment that could be used with the present invention; and

FIGS. 2A, 2B, and 2C together are a flowchart that illustrates the logic of an Expectation-Maximization algorithm performed by an Analysis Server according to a preferred embodiment of the present invention.

### DETAILED DESCRIPTION OF THE PREFERRED EMBODIMENT

In the following description of the preferred embodiment, reference is made to the accompanying drawings which form a part hereof, and in which is shown by way of illustration a specific embodiment in which the invention may be practiced. It is to be understood that other embodiments may be utilized and structural changes may be made without departing from the scope of the present invention.

### Overview

The present invention implements a Gaussian Mixture Model using an Expectation-Maximization (EM) algorithm. This implementation provides significant enhancements to a Gaussian Mixture Model that is performed by a data mining system. These enhancements allow the algorithm to:

perform in a more robust and reproducible manner,

aid user selection of the appropriate analytical model for the particular problem,

improve the clarity and comprehensibility of the outputs,

heighten the algorithmic performance of the model, and

incorporate user suggestions and feedback.

### Hardware and Software Environment

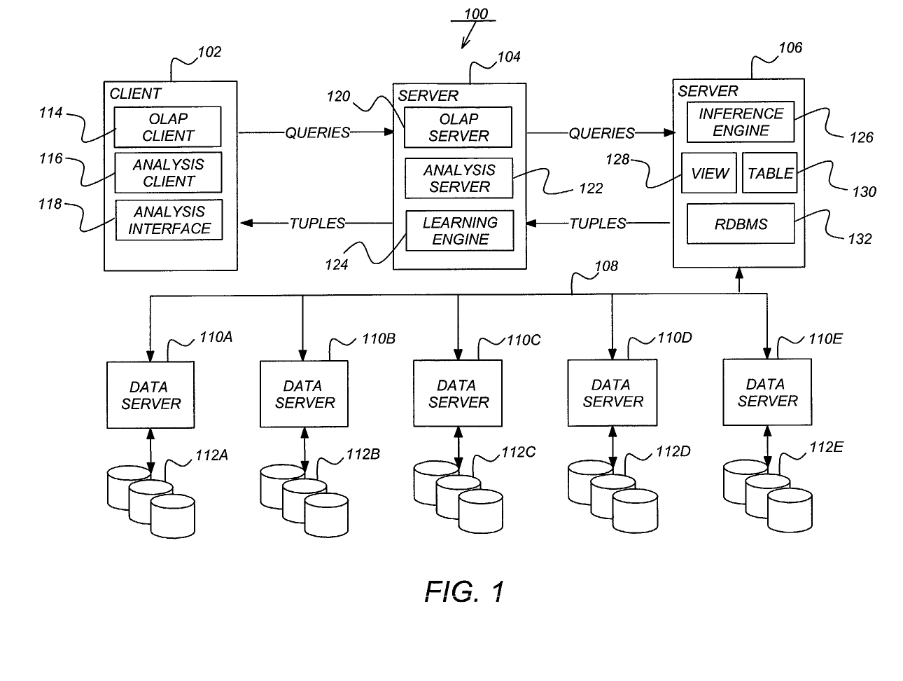

FIG. 1 illustrates an exemplary hardware and software environment that could be used with the present invention. In the exemplary environment, a computer system 100 implements a data mining system in a three-tier client-server architecture comprised of a first client tier 102, a second server tier 104, and a third server tier 106. In the preferred embodiment, the third server tier 106 is coupled via a network 108 to one or more data servers 110A-110E storing a relational database on one or more data storage devices 112A-112E.

The client tier 102 comprises an Interface Tier for supporting interaction with users, wherein the Interface Tier includes an On-Line Analytic Processing (OLAP) Client 114 that provides a user interface for generating SQL statements that retrieve data from a database, an Analysis Client 116 that displays results from a data mining algorithm, and an Analysis Interface 118 for interfacing between the client tier 102 and server tier 104.

The server tier 104 comprises an Analysis Tier for performing one or more data mining algorithms, wherein the Analysis Tier includes an OLAP Server 120 that schedules and prioritizes the SQL statements received from the OLAP Client 114, an Analysis Server 122 that schedules and invokes the data mining algorithm to analyze the data retrieved from the database, and a Learning Engine 124 performs a Learning step of the data mining algorithm. In the preferred embodiment, the data mining algorithm comprises an Expectation-Maximization procedure that creates a Gaussian Mixture Model using the results returned from the queries.

The server tier 106 comprises a Database Tier for storing and managing the databases, wherein the Database Tier includes an Inference Engine 126 that performs an Inference step of the data mining algorithm, a relational database management system (RDBMS) 132 that performs the SQL statements against a Data Mining View 128 to retrieve the data from the database, and a Model Results Table 130 that stores the results of the data mining algorithm.

The RDBMS 132 interfaces to the data servers 110A-110E as mechanism for storing and accessing large relational databases. The preferred embodiment comprises the Teradata® RDBMS, sold by NCR Corporation, the assignee of the present invention, which excels at high volume forms of analysis. Moreover, the RDBMS 132 and the data servers 110A-110E may use any number of different parallelism mechanisms, such as hash partitioning, range partitioning, value partitioning, or other partitioning methods. In addition, the data servers 110 perform operations against the relational database in a parallel manner as well.

Generally, the data servers 110A-110E, OLAP Client 114, Analysis Client 116, Analysis Interface 118, OLAP Server 120, Analysis Server 122, Learning Engine 124, Inference Engine 126, Data Mining View 128, Model Results Table 130, and/or RDBMS 132 each comprise logic and/or data tangibly embodied in and/or accessible from a device, media, carrier, or signal, such as RAM, ROM, one or more of the data storage devices 112A-112E, and/or a remote system or device communicating with the computer system 100 via one or more data communications devices.

However, those skilled in the art will recognize that the exemplary environment illustrated in FIG. 1 is not intended to limit the present invention. Indeed, those skilled in the art will recognize that other alternative environments may be used without departing from the scope of the present invention. In addition, it should be understood that the present invention may also apply to components other than those disclosed herein.

For example, the 3-tier architecture of the preferred embodiment could be implemented on 1, 2, 3 or more independent machines. The present invention is not restricted to the hardware environment shown in FIG. 1.

### Operation of the Data Mining System

The Expectation-Maximization (EM) Algorithm assumes that the data accessed from the database can be fitted by a linear combination of normal distributions. The probability density function (pdf) for the normal (Gaussian) distribution on one variable [6] is:

$$p ( x ) = \frac{1}{\sqrt{2 {πσ}^{2}}} exp ( \frac{- {( x - μ )}^{2}}{2 {σ}^{2}} )$$

This density has expected values E[x]=μ, E[x′]=σ². The mean of the distribution is μ and its variance is σ². In general, samples from variables having this distribution tend to form clusters around the mean μ. The points scatter around the mean is measured by σ².

The multivariate normal density for p-dimensional space is a generalization of the previous function [6]. The multivariate normal density for a p-dimensional vector x=x₁, x₂, . . . , xₚ is

$$p ( x ) = \frac{1}{{( 2 π )}^{p / 2} {\vert \sum \vert}^{1 / 2}} exp [ - \frac{1}{2} {( x - μ )}^{′} {\sum }^{- 1} ( x - μ ) ]$$

where μ is the mean and Ε is the covariance matrix, and μ is a p-dimensional vector and Ε is a p×p matrix. |Ε| is the determinant of Ε, and the −1 and ′ superscripts indicate inversion and transposition, respectively. Note that this formula reduces to the formula for a single variate normal density when p==1.

The quantity ∂² is called the squared Mahalanobis distance:

∂²=(x−μ)′Ε⁻¹(x−μ)

These two formulas are the basic ingredient to implementing EM in SQL.

The EM algorithm assumes that the data is formed by the mixture of multivariate normal distributions on variables. The likelihood that the data was generated by the mixture of normals is given by the following formula:

$$p ( x ) = {\sum }_{i = 1}^{k} {w}_{i} p ( x , i )$$

where p( ) is the normal probability density function for each cluster and is the fraction (weight) that cluster represents from the entire database. It is important to note that the present invention focuses on the case where there are different clusters, each having their corresponding vector and all of them having the same covariance matrix Ε.

TABLE 1
Matrix sizes

| Size | Value |
|---|---|
| k | number of clusters |
| p | dimensionality of the data |
| n | number of data points |

TABLE 2
Gaussian Mixture parameters

| Matrix | Size | Contents | Description |
|---|---|---|---|
| C | p x k | means (m) | k cluster centroids |
| R | p x p | covariances (S) | cluster shapes |
| W | k x l | priors (w) | cluster weights |

Clustering

There are two basic approaches to perform clustering: based on distance and based on density. Distance-based approaches identify those regions in which points are close to each other according to some distance function. On the other hand, density-based clustering finds those regions that are more highly populated than adjacent regions. Clustering algorithms can work in a top-down (hierarchical [10]) or a bottom-up (agglomerative) fashion. Bottom-up algorithms tend to be more accurate but slower.

The EM algorithm [12] is based on distance computation. It can be seen as a generalization of clustering based on computing a mixture of probability distributions. It works by successively improving the solution found so far. The algorithm stops when the quality of the current solution becomes stable. The quality of the current solution is measured by a statistical quantity called log-likelihood (llh). The EM algorithm is guaranteed not to decrease log-likelihood at every iteration [4]. The goal of the EM algorithm is to estimate the means (C), the covariances (R) and the mixture weights (W) of the Gaussian mixture probability function described in the previous subsection.

This algorithm starts from an approximation to the solution. This solution can be randomly chosen or it can be set by the user. It must be pointed out that this algorithm can get stuck in a locally optimal solution depending on the initial approximation. So, one of the disadvantages of EM is that it is sensitive to the initial solution and sometimes it cannot reach the global optimal solution. The parameters estimated by the EM algorithm are stored in the matrices described in Table 2 whose sizes are shown in Table 1.

Implementation of the EM Algorithm

The EM algorithm has two major steps: the Expectation (E) step and the Maximization (M) step. EM executes the E step and the M step as long as the change in log-likelihood (llh) is greater than ε.

The log-likelihood is computed as:

$$llh = {\sum }_{n} ln ( sum ( {w}_{k} {p}_{k} ) )$$

The variables δ, p, x are n×k matrices storing Mahalanobis distances, normal probabilities and responsibilities, respectively, for each of the points. This is the basic framework of the EM algorithm, as well as the basis of the present invention.

There are several important observations. C′, R′ and W′ are temporary matrices used in computations. Note that they are not the transpose of the corresponding matrix. W==1, that is the sum of the weights across all clusters equals one. Each column of C is a cluster.

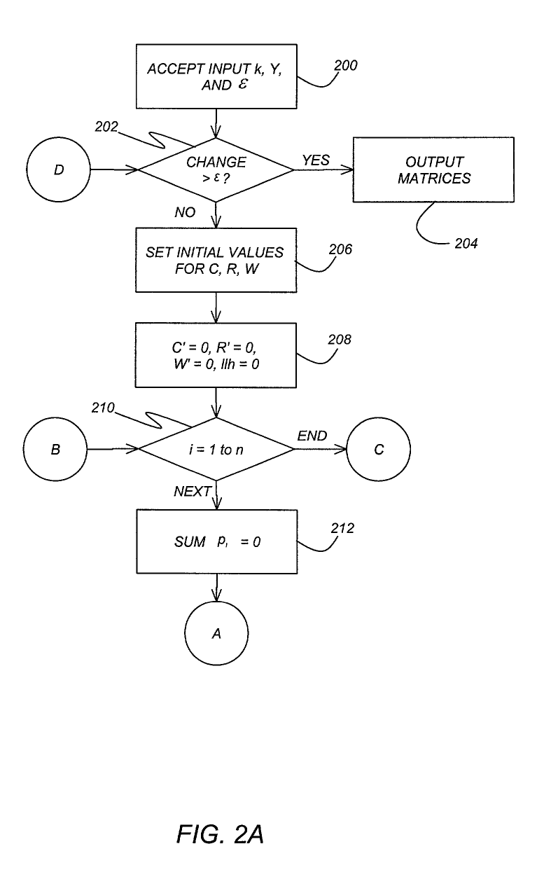

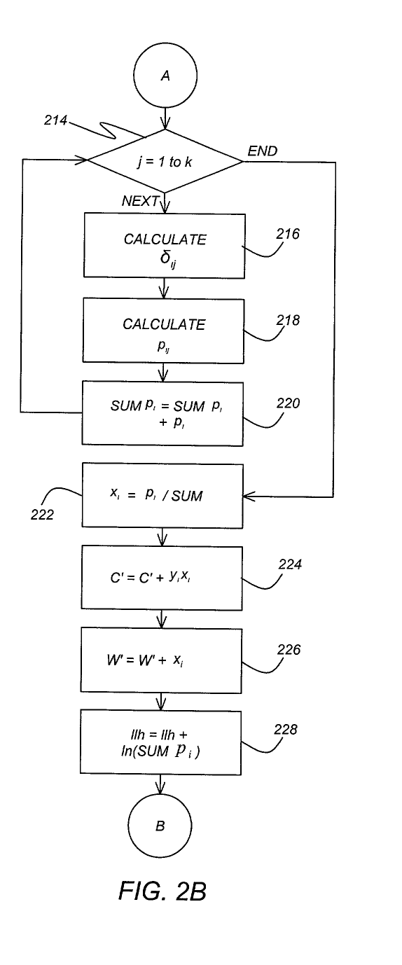

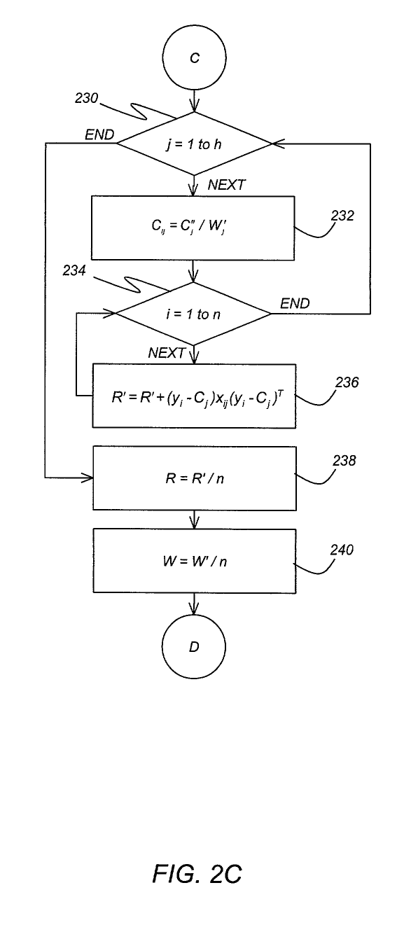

FIGS. 2A-2C together are a flowchart that illustrates the logic of the EM algorithm according to the preferred embodiment of the present invention. Preferably, this logic is performed by the Analysis Server 122, the Learning Engine 124, and the Inference Engine 126.

Referring to FIG. 2A, Block 200 represents the input of several variables, including (1) k, which is the number of clusters, (2) Y=(y1, . . . , yn), which is a set of points, where each point is a p-dimensional vector, and (3) ε, a tolerance for the log-likelihood llh.

Block 202 is a decision block that represents a WHILE loop, which is performed while the change in log-likelihood llh is greater than E. For every iteration of the loop, control transfers to Block 204. Upon completion of the loop, control transfers to Block 206 that produces the output, including (1) C, R, W, which are matrices containing the updated mixture parameters with the highest log-likelihood, and (2) X, which is a matrix storing the probabilities for each point belonging to each of the clusters (the X matrix is helpful in classifying the data according to the clusters).

Block 204 represents the setting of initial values for C, R, and W.

Block 208 represents the setting of C′=0, R′=0, W′=0, and llh=0.

Block 210 is a decision block that represents a loop for i=1 to n. For every iteration of the loop, control transfers to Block 212. Upon completion of the loop, control transfers to FIG. 2B via “C”.

Block 212 represents the calculation of:

SUM Pᵢ=0

Control then transfers to Block 214 in FIG. 2B via “A”.

Referring to FIG. 2B, Block 214 is a decision block that represents a loop for j=1 to k. For every iteration of the loop, control transfers to Block 216. Upon completion of the loop, control transfers to Block 222.

Block 216 represents the calculation of δᵢⱼ according to the following:

δᵢⱼ=(yᵢ−Cⱼ)′R⁻¹(yᵢ−Cⱼ)

Block 218 represents the calculation of pᵢⱼ according to the following:

$${p}_{ij} = \frac{w}{{( 2 π )}^{p / 2} {\vert R \vert}^{1 / 2}} exp ( - \frac{1}{2} {\partial }_{2} )$$

Block 220 represents the summation of pi according to the following:

SUM pᵢ=SUM pᵢ+pᵢ

Block 222 represents the calculation of xi according to the following:

xᵢ=pᵢ/SUM pᵢ

Block 224 represents the calculation of C′ according to the following:

C′=C′+yᵢxᵢ

Block 226 represents the calculation of W′ according to the following:

W′=W′+xᵢ

Block 228 represents the calculation of llh according to the following:

llh=llh+1n(SUM pᵢ)

Thereafter, control transfers to Block 210 in FIG. 2A via “B.”

Referring to FIG. 2C, Block 230 is a decision block that represents a loop for j=1 to h. For every iteration of the loop, control transfers to Block 232. Upon completion of the loop, control transfers to Block 238.

Block 232 represents the calculation of Cᵢⱼ according to the following:

Cᵢⱼ=Cⱼ″/Wⱼ′

Block 234 is a decision block that represents a loop for i=1 to n. For every iteration of the loop, control transfers to Block 236. Upon completion of the loop, control transfers to Block 230.

Block 236 represents the calculation of R′ according to the following:

R′=R′+(yᵢ−Cⱼ)xᵢⱼ(yᵢ−Cⱼ)^{T}

Block 238 represents the calculation of R according to the following:

R=R′/n

Block 240 represents the calculation of W according to the following:

W=W′/n

Thereafter, control transfers to Block 202 in FIG. 2A via “D.”

Note that Block 206-228 represent the E step and Blocks 230-240 represent the M step.

In the above computations, Cⱼ is the jth column of C, yᵢ is the ith data point of Y, and R is a diagonal matrix. Statistically, this means that the covariances are independent of one another. This diagonality of R is a key assumption to allow linear Gaussian matrix models to run efficiently with the EM algorithm. The determinant and the inverse of R can be computed in time O(p). Note that under these assumptions the EM algorithm has complexity O(kpn). The diagonality of R is a key assumption for the SQL implementation. Having a non-diagonal matrix would change the time complexity to O(kp^{3 n) [}14][15].

Simplifying and Optimizing the EM Algorithm

The following section describes the improvements contributed by the preferred embodiment of the present invention to the simplification and optimization of the EM algorithm, and the additional changes necessary to make a robust Gaussian Mixture Model. These improvements are discussed in the five sections that follow: Robustness, Model Selection, Clarity of Output, Performance Improvements, and Incorporation of User Feedback.

Robustness

There are several additions in this area, all addressing issues that occur when the data, in one form or another, does not conform perfectly to the specifications of the model.

|R|=0 means that at least one element in the diagonal of R is zero.

Problem: When there is noisy data, missing values, or categorical variables, covariances may be zero. Note that an element of the matrix R may be zero, even if the population variance of the data as a whole is finite.

Solution: In Block 206 of FIG. 2A, variables whose covariance is null are skipped and the dimensionality of the data is scaled accordingly.

Outlier handling using distances, i.e. when p(x)=0, where p(x) is the pdf for the normal distribution.

Problem: When the points do not adjust to a normal distribution cleanly, or when they are far from cluster means, the negative exponential function becomes zero very rapidly. Even when computations are made using double precision variables, the very small numbers generated by outliers remain an issue. This phenomenon has been observed both in RBMS's, as well as in Java.

Solution: In Block 222 of FIG. 2B, instead of using the Normal pdf, p(xij)=pij, the reciprocal of the Mahalanobis distances is used to approximate responsibilities:

$${x}_{ij} = \frac{1 / \partial }{\sum 1 / \partial }$$

This equation is known as the modified Cauchy distribution. The Cauchy distribution effectively computes responsibilities having the same order for membership. In addition, this improvement does not slow down the program since responsibilities are calculated first thing during the expectation step.

Initialization that avoids repeated runs but may require more iterations in a single run.

Problem: The user may not know how to initialize or seed the cluster. The user does not want to perform repeated runs to test different prospective solutions.

Solution: In Block 206 of FIG. 2A, random numbers are generated from a uniform (0,1) distribution for C. The difference in the last digits will accelerate convergence to a good global solution.

Note that a comparable solution is to compute the k-means model as an initialization to the full Gaussian Mixture Model. Effectively, this means setting all elements of the R matrix to some small number, e, for a set number of iterations, such as five. On subsequent estimation runs, the full data is used to estimate the covariance matrix R. The two methods are quite similar, although the random initialization promotes a gradual convergence to the answer; the k-means method attempts no estimation during the initialization runs.

Calculation of the log plus one of the data.

Solution: This is performed in Block 228 of FIG. 2B to effectively pull in the tails, thereby strongly limiting the number of outliers in the data.

Intercluster distance to distinguish segments.

Problem: Provide the ability to tell differences between clusters. When k is large, it often happens that clusters are repeated. Also, clusters may be equal in most variables (projection), but different in a few.

Solution: In Block 216 of FIG. 2B, given Cₐ, C_{b}, the Mahalanobis distances between clusters can be computed to see how similar they are:

∂(Cₐ, C_{b})=(Cₐ−C_{b})′R⁻¹(Cₐ−C_{b})′

The closer this quantity is to zero, the more likely both clusters are the same.

Model Selection

Model selection involves deciding which of various possible Gaussian Mixture Models are suitable for use with a given data set. Unfortunately, these decisions require considerable software, database, and statistical knowledge. The present invention eases this requirements with a set of pragmatic choices in model selection.

Model specification with common covanances.

Problem: With k clusters, and p variables, it would require (k×p×p) parameters to fully describe the R matrix. This is because in a full Gaussian Mixture Model, each Gaussian may be distributed in a different manner. This number of parameters causes an explosion of necessary output, complicating model storage, transmission and interpretation.

Solution: In Block 202 of FIG. 2A, identical covariance matrices are used for all clusters, which provides two advantages. First, it keeps the total number of model parameters down, wherein, in general, the reduction is related to k, the number of clusters selected for the model. Second, identical covariance matrices allow there to be linear discriminants between the clusters, which means that linear regions can be carved out of the data that describe which data points will fall into which clusters.

Model specification with independent covariances.

Problem: The multivariate normal distribution allows for conditionally dependent variables. With even moderate numbers of variables, the possible permutations of covariances are extremely high. This causes singularities in the computation of log-likelihood.

Solution: Block 200 of FIG. 2A formulates the model so that variables are independent of one another. Although this assumption is rarely correct in practice, the resulting clusters serve as useful first-order approximations to the data. There are a number of additional advantages to the assumption. Keeping the covariances independent of one another keeps the total number of parameters lower, ensuring robust and repeatable model results. The total number of parameters with independent and common covariances is (p+2)×k. This is very different from the situation with dependent covariances and distinct covariance matrices; this situation requires (p+p×p)×k+k parameters. In the not unusual situation where (k==25, p==30), specifying the full model requires over 23,000 parameters, which is an increase in variables of over 30-fold. (The difference is proportional to p). Independent variables assure an analytic solution to the clustering problem. Finally, independent variables ease the computational problem (see below, Performance Improvements.)

Model selection using Akaike's Information Criteria.

Problem: It is necessary to select the optimum number of clusters for the model. Too few clusters, and the model is a poor fit to the data. Too many clusters, and the model does not perform well when generalized to new data.

Solution: Block 228 of FIG. 2B performs the EM algorithm with different numbers of clusters keeping track of log-likelihood and the total number of parameters. Akaike's Information Criteria combines these two parameters, wherein the highest AIC is the best model. Akaike's Information Criteria, and several related model selection criteria, are discussed in reference [16].

Clarity of Output

Some of the most significant problems in data mining result from communicating the results of an analytical model to its shareholders, i.e., those who must implement or act upon the result. A number of modifications have been made in this area to improve the standard Gaussian Mixture Model.

Providing decision rules to justify clustering or partitioning of the data.

Problem: Business users expect a simply reported rule which will describe why the data has been clustered in a particular fashion. The challenge is that a Gaussian Mixture Model is able to produce very subtle distinctions between clusters. Without assistance, users may not comprehend the clustering criteria, and therefore not trust the model outputs. Simply reporting cluster results, or classification results, is not sufficient to convince naive users of the veracity of the clustering results.

Solution: Block 204 of FIG. 2A calculates linear discriminants, also known as decision rules. These rules highlight the significant differences between the segments and they do not merely summarize the output. Moreover, linear discriminants are easily computed in SQL, and are easily communicated to users. Intuitively, the linear discriminants are understood as the “major differences” between the clusters.

The formula for calculating the linear discriminant from the matrix outputs is as follows:

v′(x−x₀)=0,

where

v=Ε⁻¹(μₐ−μ_{b})

$${x}_{0} = \frac{1}{2} ( {μ}_{a} - {μ}_{b} ) - \frac{log \frac{P ( {w}_{a} )}{P ( {w}_{b} )}}{{( {μ}_{a} - {μ}_{b} )}^{′} {\sum }^{- 1} ( {μ}_{a} - {μ}_{b} )}$$

Note that in this formula, a and b represent any two clusters for which a boundary description is desired [6]. The linear decision rule typically describes a hyperplane in p dimensions. However, it is possible to simplify the plane to a line, providing a single metric illustrating why a point falls to a given cluster. This can be performed by removing the (p−2) lowest coefficients of the linear discriminant and setting them to zero. Classification accuracy will suffer.

Cluster sorting to ease result interpretation.

Problem: Present the user with results in the same format and order. This is useful, since if no hinting is used, EM departs from a random solution and then matrices C and W have their contents shuffled in repeated runs.

Solution: Block 204 in FIG. 2A sorts columns of the output matrices by their contents in lexicographical order with variables going from 1 to p.

Import/export standard format for text file with C,R,W and their flags.

Problem: Model parameters must be input and output in standard formats. This ensures that the results may be saved and reused.

Solution: Block 204 in FIG. 2A creates a standard output for the Gaussian Mixture Model, which can be easily exported to other programs for viewing, analysis or editing.

Comprehensibility of model progress indicators.

Problem: The model reports likelihood as a measure of model quality and model progress. The measure which ranges from negative infinity to zero, lacks comprehensibility to users. This is despite its analytically well-defined meaning, and its theoretical basis in probability.

Solution: Block 228 of FIG. 2B uses the log ratio of likelihood, as opposed to the log-likelihood to track progress. This shows a number that gets closer to 100% when the algorithm is converging.

Note that another potential metric would be the number of data points reclassified in each iteration. This would converge from nearly 100% of data points, to near 0% as the solution gained in stability. An advantage of both the log ratio and the reclassification metric is the fact that they are neatly bounded between zero and one. Unfortunately, neither metric is guaranteed monoticity, i.e. the model progress can apparently get worse before it gets better again. The original metric, log-likelihood, is assured of monoticity.

Algorithmic Performance

Accelerated matrix computations using diagonality of R.

Problem: Perform matrix computations as fast as possible assuming a diagonal matrix.

Solution: Block 216 of FIG. 2B accelerates matrix products by only computing products that do not become zero. The important sub-step in the E step is computing the Mahalanbois distances δᵢⱼ. Remember that R is assumed to be diagonal. A careful inspection of the expression reveals that when R is diagonal, the Mahalanobis distance of point y to cluster mean C (having covariance R ) is:

$${\partial }^{2} = {( y - C )}^{′} {R}^{- 1} ( y - C ) = {\sum }_{p} \frac{{( {y}_{p} - {C}_{p} )}^{2}}{{R}_{p}}$$

This is because the inverse of Rᵢⱼ is one over Rᵢⱼ. For a non-singular diagonal matrix, the inverse of R is easily computed by taking the multiplicative inverses of the elements in the diagonal. All off-diagonal elements of the matrix R are zero. A second observation is that a diagonal matrix R can be stored in a vector. This saves space, and more importantly, speeds up computations. Consequently, R can be indexed with just one subscript. Since R does not change during the E step, its determinant can be computed only once, making probability computations pᵢⱼ in the computation (y−C)×(y−c)′ become zero. In simpler terms, Rᵢ=R₁=Xᵢⱼ(yᵢⱼ−Cᵢⱼ)² is faster to compute. The rest of the computations can not be further optimized computationally.

Ability to run E or M steps separately.

Problem: Estimate log-likelihood, i.e., obtain global means or covariances, to make the clustering process more interactive.

Solution: Block 240 of FIG. 2C computes responsibilities and log-likelihood in E step only and update parameters only in M step. This provides the ability to run the steps independently if needed.

Improved log-likelihood computation, with holdouts.

Problem: Handle noisy data having many missing values or having values that are hard to cluster.

Solution: Block 228 of FIG. 2B scales log-likelihood with n, and exclude variables for which distances are above some threshold

Ability to stop/resume execution when desired by the user.

Problem: The user should be able to get results computed so far if the program gets interrupted.

Solution: The software implementation incorporates anytime behavior, allowing for fail-safe interruption.

Automatically mapped variables for variable subsetting.

Problem: On repeated runs, users may add or delete variables from the global list. This causes problems in the comparison of results across repeated runs.

Solution: The variables are omitted by the program, and the name and origination of the variable is maintained. Because the computational complexity of the program is linear in the number of variables, dropping variables (instead of using dummy variables) allows the program to run more efficiently.

Incorporation of User Feedback

The standard Gaussian Mixture Model learns model parameters automatically. This is the tougher problem in machine learning, thereby allowing systems to identify parameters without user input. For practical purposes, however, it is valuable to mix both user feedback with machine learning to achieve optimal results. Domain specific knowledge may offer the human user specific insight into the problem not available to a machine, and it may also lead them to value certain solutions which do not necessarily meet a statistical criterion of optimality. Therefore, incorporation of user feedback is an important addition to a production-scale system, and made the following changes accordingly.

Hinting and constraining.

Problem: Sometimes, users have valuable feedback that they wish to incorporate into the model. Sometimes, particular areas of the database are of business interest, even if there is no a prior reason to favor the area statistically.

Solution: A set of changes are incorporated by which users may hint and constrain C, R, W, or any combination thereof. Atomic control over the calculations with flags is permitted. Hinting means that the users' suggestions for model solution are evaluated. Constraining means that a portion of the solution is pre-specified by the user. Note that the model as implemented will still run with little or no user feedback, and these additions allow users to incorporate feedback only if they so please.

Computation to rescale W.

Problem: The Gaussian Mixture Model treats all data points equally for the purposes of fitting the model. This means that the weights, W, sum to 1 for each data point in the model. Unfortunately, some constraints on the model can force these weights to no longer equal zero.

Solution: A set of additions to the weight matrix are implemented that rectify weights that do not sum to equality because of user constraints.

### References

The following references are incorporated by reference herein:

[1] C. Aggarwal, C. Procopiuc, J. Wolf, P. Yu, and J. S. Park. Fast algorithms for projected clustering. In Proceedings of the ACM SIGMOD International Conference on Management of Data, Philadelphia, Pa., 1999.

[2] Rakesh Agrawal, Johannes Gehrke, Dimitrios Gunopolos, and Prabhakar Raghavan. Automatic subspace clustering of high dimensional data for data mining applications. In Proceedings of the ACM SIGMOD International Conference on Management of Data, Seattle, Wash., 1998.

[3] Paul Bradley, Usama Fayyad, and Cory Reina. Scaling clustering algorithms to large databases. In Proceedings of the Int'l Knowledge Discovery and Data Mining Conference (KDD), 1998.

[4] A. P. Dempster, N. M. Laird, and D. B. Rubin. Maximum likelihood estimation from incomplete data via the EM algorithm. Journal of The Royal Statistical Society, 39(1):1-38, 1977.

[5] R. Dubes and A. K. Jain. Clustering Methodologies in Exploratory Data Analysis, pages 10-35. Academic Press, New York, 1980.

[6] Richard Duda and Peter Hart. Pattern Classification and scene analysis. John Wiley and Sons, 1973.

[7] Martin Easter, Hans Peter Kriegel, and X. Xu. A density-based algorithm for discovering clusters in large spatial databases with noise. In Proceedings of the IEEE International Conference on Data Engineering (ICDE), Portland, Oreg., 1996.

[8] Alexander Hinneburg and Daniel Keim. Optimal grid-clustering: Towards breaking the curse of dimensionality. In Proceedings of the 25th International Conference on Very Large Data Bases, Edinburgh, Scotland, 1999.

[9] M. I. Jordan and R. A. Jacbos. Hierarchical mixtures of experts and the em algorithm. Neural Computation, 6(2), 1994.

[10] F. Murtagh. A survey of recent advances in hierarchical clustering algorithms. The Computer Journal, 1983.

[11] R. Ng and J. Han. Efficient and effective clustering method for spatial data mining. In Proc. of the VLDB Conference, Santiago, Chile, 1994.

[12] Sam Roweis and Zoubin Ghahramani. A unifying review of linear gaussian models. Journal of Neural Computation, 1999.

[13] T. Zhang, R. Rmakrishnan, and M. Livny. Birch: An efficient data clustering method for very large databases.

[14] In Proc. of the ACM SIGMOD Conference, Montreal, Canada, 1996. A. Beaumont-Smith, 11vI. Leibelt, C. C. Lim, K. To and W. Marwood, “A Digital Signal Multi-Processor for Matrix Applications”, 14th Australian Microelectronics Conference, 1997, Melbourne.

[15] Press, W. H., B. P. Flannery, S. A. Teukolsky and W. T. Vetterling (1986), Numerical Recipes in C, Cambridge University Press: Cambridge.

[16] Bozdogan, H. (1987). Model selection and Akaike's information criterion (AIC): The general theory and its analytical extensions. Psychometrika, 52, 345-370.

### Conclusion

This concludes the description of the preferred embodiment of the invention. The following paragraphs describe some alternative embodiments for accomplishing the same invention.

In one alternative embodiment, any type of computer could be used to implement the present invention. For example, any database management system, decision support system, on-line analytic processing system, or other computer program that performs similar functions could be used with the present invention.

In summary, the present invention discloses a computer-implemented data mining system that analyzes data using Gaussian Mixture Models. The data is accessed from a database, and then an Expectation-Maximization (EM) algorithm is performed in the computer-implemented data mining system to create the Gaussian Mixture Model for the accessed data. The EM algorithm generates an output that describes clustering in the data by computing a mixture of probability distributions fitted to the accessed data.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A method for creating analyzing data in a computer-implemented data mining system, comprising:
(a) accessing data from a database in the computer-implemented data mining system; and
(b) performing an Expectation-Maximization (EM) algorithm in the computer-implemented data mining system to create the Gaussian Mixture Model for the accessed data, wherein the EM algorithm generates an output that describes clustering in the data by computing a mixture of probability distributions fitted to the accessed data.

2. The method of claim 1, wherein the EM algorithm is performed iteratively to successively improve a solution for the Gaussian Mixture Model.

3. The method of claim 2, wherein the EM algorithm terminates when the solution becomes stable.

4. The method of claim 2, wherein the solution is measured by a statistical quantity.

5. The method of claim 2, wherein the EM algorithm begins with an approximation to the solution.

6. The method of claim 2, wherein the EM algorithm uses a log ratio of likelihood to determine whether the solution has improved.

7. The method of claim 1, wherein the EM algorithm skips variables in the accessed data whose covariance is null and rescales the data's dimensionality accordingly.

8. The method of claim 1, wherein the EM algorithm uses a reciprocal of a Mahalanobis distances to approximate responsibilities in the accessed data.

9. The method of claim 1, wherein the EM algorithm generates random numbers from a uniform (0,1) distribution for a means for the accessed data.

10. The method of claim 1, wherein the EM algorithm calculates a log-liklihood of the accessed data.

11. The method of claim 1, wherein the EM algorithm uses an intercluster distance to distinguish segments in the accessed data.

12. The method of claim 1, wherein the EM algorithm uses identical covariance matrices for all clusters in the accessed data.

13. The method of claim 1, wherein the EM algorithm formulates the Gaussian Mixture Model so that variables are independent of one another.

14. The method of claim 1, wherein the EM algorithm is performed using different numbers of clusters in the accessed data, keeping track of a log-likelihood and a total number of parameters.

15. The method of claim 1, wherein the EM algorithm calculates linear discriminants that highlight significant differences between the segments in the accessed data.

16. The method of claim 1, wherein the EM algorithm accelerates matrix products by only computing products that do not become zero.

17. The method of claim 1, wherein the EM algorithm computes responsibilities and log-likelihood in an Expectation step only and updates parameters in a Maximization step only.

18. The method of claim 1, wherein the EM algorithm scales log-likelihood with n, and excludes variables for which distances are above some threshold.

19. The method of claim 1, wherein the EM algorithm implements a set of additions to a weight matrix that rectify weights that do not sum to equality because of user constraints.

20. A computer-implemented data mining system for analyzing data, comprising:
(a) a computer;
(b) logic, performed by the computer, for:
(1) accessing data stored in a database; and
(2) performing an Expectation-Maximization (EM) algorithm to create the Gaussian Mixture Model for the accessed data, wherein the EM algorithm generates an output that describes clustering in the data by computing a mixture of probability distributions fitted to the accessed data.

21. The system of claim 20, wherein the EM algorithm is performed iteratively to successively improve a solution for the Gaussian Mixture Model.

22. The system of claim 21, wherein the EM algorithm terminates when the solution becomes stable.

23. The system of claim 21, wherein the solution is measured by a statistical quantity.

24. The system of claim 21, wherein the EM algorithm begins with an approximation to the solution.

25. The system of claim 21, wherein the EM algorithm uses a log ratio of likelihood to determine whether the solution has improved.

26. The system of claim 20, wherein the EM algorithm skips variables in the accessed data whose covariance is null and rescales the data's dimensionality accordingly.

27. The system of claim 20, wherein the EM algorithm uses a reciprocal of a Mahalanobis distances to approximate responsibilities in the accessed data.

28. The system of claim 20, wherein the EM algorithm generates random numbers from a uniform (0,1) distribution for a means for the accessed data.

29. The system of claim 20, wherein the EM algorithm calculates a log-liklihood of the accessed data.

30. The system of claim 20, wherein the EM algorithm uses an intercluster distance to distinguish segments in the accessed data.

31. The system of claim 20, wherein the EM algorithm uses identical covariance matrices for all clusters in the accessed data.

32. The system of claim 20, wherein the EM algorithm formulates the Gaussian Mixture Model so that variables are independent of one another.

33. The system of claim 20, wherein the EM algorithm is performed using different numbers of clusters in the accessed data, keeping track of a log-likelihood and a total number of parameters.

34. The system of claim 20, wherein the EM algorithm calculates linear discriminants that highlight significant differences between the segments in the accessed data.

35. The system of claim 20, wherein the EM algorithm accelerates matrix products by only computing products that do not become zero.

36. The system of claim 20, wherein the EM algorithm computes responsibilities and log-likelihood in an Expectation step only and updates parameters in a Maximization step only.

37. The system of claim 20, wherein the EM algorithm scales log-likelihood with n, and excludes variables for which distances are above some threshold.

38. The system of claim 20, wherein the EM algorithm implements a set of additions to a weight matrix that rectify weights that do not sum to equality because of user constraints.

39. An article of manufacture embodying logic for analyzing data in a computer-implemented data mining system, the logic comprising:
(a) accessing data from a database in the computer-implemented data mining system; and
(b) performing an Expectation-Maximization (EM) algorithm in the computer-implemented data mining system to create the Gaussian Mixture Model for the accessed data, wherein the EM algorithm generates an output that describes clustering in the data by computing a mixture of probability distributions fitted to the accessed data.

40. The article of manufacture of claim 39, wherein the EM algorithm is performed iteratively to successively improve a solution for the Gaussian Mixture Model.

41. The article of manufacture of claim 40, wherein the EM algorithm terminates when the solution becomes stable.

42. The article of manufacture of claim 40, wherein the solution is measured by a statistical quantity.

43. The article of manufacture of claim 40, wherein the EM algorithm begins with an approximation to the solution.

44. The article of manufacture of claim 40, wherein the EM algorithm uses a log ratio of likelihood to determine whether the solution has improved.

45. The article of manufacture of claim 39, wherein the EM algorithm skips variables in the accessed data whose covariance is null and rescales the data's dimensionality accordingly.

46. The article of manufacture of claim 39, wherein the EM algorithm uses a reciprocal of a Mahalanobis distances to approximate responsibilities in the accessed data.

47. The article of manufacture of claim 39, wherein the EM algorithm generates random numbers from a uniform (0,1) distribution for a means for the accessed data.

48. The article of manufacture of claim 39, wherein the EM algorithm calculates a log-liklihood of the accessed data.

49. The article of manufacture of claim 39, wherein the EM algorithm uses an intercluster distance to distinguish segments in the accessed data.

50. The article of manufacture of claim 39, wherein the EM algorithm uses identical covariance matrices for all clusters in the accessed data.

51. The article of manufacture of claim 39, wherein the EM algorithm formulates the Gaussian Mixture Model so that variables are independent of one another.

52. The article of manufacture of claim 39, wherein the EM algorithm is performed using different numbers of clusters in the accessed data, keeping track of a log-likelihood and a total number of parameters.

53. The article of manufacture of claim 39, wherein the EM algorithm calculates linear discriminants that highlight significant differences between the segments in the accessed data.

54. The article of manufacture of claim 39, wherein the EM algorithm accelerates matrix products by only computing products that do not become zero.

55. The article of manufacture of claim 39, wherein the EM algorithm computes responsibilities and log-likelihood in an Expectation step only and updates parameters in a Maximization step only.

56. The article of manufacture of claim 39, wherein the EM algorithm scales log-likelihood with n, and excludes variables for which distances are above some threshold.

57. The article of manufacture of claim 39, wherein the EM algorithm implements a set of additions to a weight matrix that rectify weights that do not sum to equality because of user constraints.
